(19) United States
(12) Patent Application Publication
(10) Pub. No.: US 2014/0266997 A1
(43) Pub. Date: Sep. 18, 2014

(54) Driving Circuit of Backlight Module, Method for Driving Backlight Module, and LCD Apparatus Incorporated With Such Backlight Module

(71) Applicants: Anle Hu, Shenzhen (CN); Li Li, Shenzhen (CN)

(72) Inventors: Anle Hu, Shenzhen (CN); Li Li, Shenzhen (CN)

(73) Assignee: Shenzhen China Star Optoelectronics Technology Co., Ltd., Shenzhen, Guangdong (CN)

(21) Appl. No.: 13/879,808

(22) PCT Filed: Mar. 26, 2013
(86) PCT No.: PCT/CN2013/073162

§ 371 Date: Apr. 17, 2013

(30) Foreign Application Priority Data
Mar. 15, 2013 (CN) 201310083030.9

(51) Int. Cl. H05B 33/08; G09G 3/36

(52) U.S. Cl. CPC H05B 33/0806; G09G 3/36
USPC 345/102; 315/185 R; 315/186

(57) ABSTRACT

The present invention provides a driving circuit of backlight module, comprising: a constant-voltage IC, equipped with a voltage feedback pin leg, for outputting constant voltage, wherein the voltage feedback pin leg connects to a negative electrode of an LED string; and a detecting resistor having one end connected to the negative electrode of the LED string, and the other end is grounded. The driving circuit of backlight module, the method for driving backlight module, and the LCD apparatus incorporated with such backlight module provided by the present invention use a various and low-costed constant-voltage IC. Changing the connection of its voltage feedback pin leg, so the constant-voltage IC can output the constant voltage and keep the current flowing through the LED string constantly, and thereby the constant-current driving is realized. Under the premise that the functions remain uncompromised, the complexity and the cost of the backlight driver circuit are reduced. In light of this, the voltage feedback pin leg could output the constant voltage by setting the comparator within the constant-voltage IC, so the voltage of its noninverting input end is identical to the voltage of its inverting input end, wherein the noninverting input end connects to the constant-voltage source. As a result, the configuration of the circuit is relatively simple, and easy to implement.

The present patent application claims priority from Chinese Patent Application, No. 201310083030.9, entitled “Driving Circuit of Backlight Module, Method for Driving Backlight Module, and LCD Apparatus Incorporated With Such Backlight Module”, and filed on Mar. 15, 2013 in the China Patent Office, the entire contents of which are hereby incorporated herein by reference.

### FIELD OF THE INVENTION

The present invention relates to a technical field of an image display, and more particularly to a driving circuit of backlight module, a method for driving backlight module, and an LCD apparatus incorporated with such backlight module.

### BACKGROUND OF THE INVENTION

As the awareness of the global energy conservation and environmental protection continue to enhance, using LED as the light source of the backlight module of a LCD has become more and more common. Referring to FIG. 1, a structural and illustrational view of a prior art LED driving circuit incorporated with a constant-current IC is shown. Using the constant current is a comparably ideal and reliable method for driving LED, because it can avoid the current variations caused by the change of the LED forward voltage, and the constant current enables the brightness of the LED to be stable. However, the number of the pin legs of the constant-current IC is at least sixteen (16); as a result, the structure of the circuit is relatively complex. On the other hand, there is not many constant-current IC for selection, and the price is therefore high. Inevitably, the manufacturing cost becomes high.

### SUMMARY OF THE INVENTION

It is an object of the present invention to provide a driving circuit for backlight module with simple configuration as well as it can be cost-effectively manufactured. The present invention further includes a driving method for backlight module, and also a LCD device incorporated with such a driving method.

In order to resolve the technical issue encountered by the prior art, the present invention provides a driving circuit of backlight module, comprising: a constant-voltage IC, equipped with a voltage feedback pin leg, for outputting constant voltage, wherein the voltage feedback pin leg connects to a negative electrode of an LED string; and a detecting resistor having one end connected to the negative electrode of the LED string, and the other end is grounded.

Wherein the constant-voltage IC further includes a comparator, wherein the voltage of its noninverting input end is identical to the voltage of its inverting input end, wherein the noninverting input end connects to the constant-voltage source, and wherein the inverting input end connects to the voltage feedback pin leg.

Wherein the constant-voltage IC further includes an enabling signal pin for receiving a PWM dimming signal, wherein when the PWM signal is a high-level signal, the constant-voltage IC works normally; and wherein when the PWM signal is a low-level signal, the constant-voltage IC is shut down.

The present invention further provides a method for driving backlight module, including the steps of a) providing a constant-voltage IC; b) connecting a voltage feedback pin leg of the constant-voltage IC to a negative electrode of an LED string; and c) providing a detecting resistor having one end connected to the negative electrode of the LED string, and the other end is grounded.

Wherein before the voltage feedback pin leg of the constant-voltage IC connects to the negative electrode of the LED string, a comparator with the voltage of its noninverting input end being identical to the voltage of its inverting input end is set within the constant-voltage IC, wherein the noninverting input end connects to the constant-voltage source, and wherein the inverting input end connects to the voltage feedback pin leg.

Wherein the method for driving backlight module further includes an enabling signal pin set in the constant-voltage IC for receiving a PWM dimming signal, wherein when the PWM signal is a high-level signal, the constant-voltage IC works normally; and wherein when the PWM signal is a low-level signal, the constant-voltage IC is shut down.

The present invention further provides an LCD apparatus incorporated with a driving circuit of backlight module, comprising: a constant-voltage IC, equipped with a voltage feedback pin leg, for outputting constant voltage, wherein the voltage feedback pin leg connects to a negative electrode of an LED string; and a detecting resistor having one end connected to the negative electrode of the LED string, and the other end is grounded.

Wherein the constant-voltage IC further includes a comparator, wherein the voltage of its noninverting input end is identical to the voltage of its inverting input end, wherein the noninverting input end connects to the constant-voltage source, and wherein the inverting input end connects to the voltage feedback pin leg.

Wherein the constant-voltage IC further includes an enabling signal pin for receiving a PWM dimming signal, wherein when the PWM signal is a high-level signal, the constant-voltage IC works normally; and wherein when the PWM signal is a low-level signal, the constant-voltage IC is shut down.

The driving circuit of backlight module, the method for driving backlight module, and the LCD apparatus incorporated with such backlight module provided by the present invention use a various and low-costed constant-voltage IC. Changing the connection of its voltage feedback pin leg, so the constant-voltage IC can output the constant voltage and keep the current flowing through the LED string constantly, and thereby the constant-current driving is realized. Under the premise that the functions remain uncompromised, the complexity and the cost of the backlight driver circuit are reduced. In light of this, the voltage feedback pin leg could output the constant voltage by setting the comparator within the constant-voltage IC, so the voltage of its noninverting input end is identical to the voltage of its inverting input end, wherein the noninverting input end connects to the constant-voltage source. As a result, the configuration of the circuit is relatively simple, and easy to implement.

### BRIEF DESCRIPTION OF DRAWINGS

In order to give a better and thorough understanding to the whole and other intended purposes, features and advantages of the present invention or the technical solution of the prior art, detailed description will be given with respect to preferred embodiments provided and illustrated here below in accompanied drawings. Apparently, with the spirit of the embodiments disclosed, persons in the skilled in the art can readily come out with other modifications as well as improvements without undue experiment. In addition, other drawings can be readily achieved based on the disclosed drawings.

FIG. 1 is a structural and illustrational view of a prior art driving circuit incorporated with a constant-current IC;

FIG. 2 is a structural and illustrational view of a first embodiment of a driving circuit of backlight module made in accordance with the present invention; and

FIG. 3 is a flow-chart diagram illustrating the steps of a second embodiment of a method for driving backlight module made in accordance with the present invention.

### DETAILED DESCRIPTION OF PREFERRED EMBODIMENTS

Detailed description will be given with respect to preferred embodiments provided and illustrated here below in accompanied drawings.

The conceptual idea in accordance with the embodiment of the present invention is that taking into account the fact that the constant-voltage IC is readily available in the market; and it usually has only eight (8) pin legs. As a result, the circuit to accommodate this IC is simple to implement; and has various kinds to choose. Accordingly, the constant-current IC is replaced by the readily available eight-pin constant-voltage IC via building circuits thereof to drive the LED, and thereby the complexity and the cost of the backlight driver circuit are reduced under the premise that the functions remain uncompromised.

Referring to FIG. 2, a driving circuit of backlight module made in accordance with the first embodiment of the present invention includes the following elements. A constant-voltage IC, equipped with a voltage feedback pin leg (FB pin), for outputting constant voltage, wherein the voltage feedback pin leg connects to a negative electrode of an LED string; and a detecting resistor R2 has one end connected to the negative electrode of the LED string, and the other end is grounded.

The working principle is: the current flowing through the LED string is I; wherein the amount of the current can be expressed with: I=V_{R2}/R2; and wherein V_{R2} is the voltage drop between the detecting resistor R2. Because one end of R2 is grounded, and with the other end connected to the negative electrode of the LED string, and the voltage feedback pin leg is also connected to a negative electrode of an LED string, then V_{R2}=V_{FB}, wherein V_{FB} is the voltage output from the constant-voltage IC. V_{FB} keeps as a constant, so the current I flowing through the LED string is also constant to facilitate constant-current driving. The amount of the current I can be adjusted by regulating the resistance of the resistor R2 in order to meet different application needs.

Substantially, the constant voltage output by the voltage feedback pin leg can be facilitated by the following method. A comparator with the voltage of its noninverting input end (+) being identical to the voltage of its inverting input end (−) is set within the constant-voltage IC, wherein the noninverting input end is connected to the constant-voltage source, and wherein the inverting input end is connected to the voltage feedback pin leg. As mentioned previously, the voltage drop between the detecting resistor R2 is V_{R2} which equals to V_{FB}, i.e. V_{R2}=V_{FB}. In this case, V_{FB} is the voltage of its inverting input end of the comparator within the constant-voltage IC, which equals to the voltage of the voltage feedback pin leg. Because the voltage of the noninverting input end of the comparator is identical to the voltage of its inverting input end, and wherein the noninverting input end connects to the constant-voltage source, as a result V_{FB} will keep constantly, and thereby the current I flowing through the LED string is also kept as a constant to realize constant-current driving. As regards to the specific value of the voltage of the constant-voltage source connected by the noninverting input end, it can be determined by the design of the constant-voltage IC, and there is no limitation in the present invention.

It should be noted and specially explained that because the temperature will rise during the process of operation of LED string, its forward voltage drop will decrease with the rise of the temperature. The current may increase greatly as resulted from constant-voltage driving, so the temperature of the LED will further increase as resulted in this vicious cycle. Accordingly, in the prior art practice, a constant-voltage circuit configured by a constant-current IC utilizes a measurement of connecting a voltage feedback pin leg to a positive electrode of the LED string through a voltage divider to detect the real-time voltage from the output end. In the present invention, although the driving circuit of backlight module is incorporated with the constant-current IC, changes of the connection of its voltage feedback pin leg enable the constant-current driving, and retain the advantages of constant-current driving. In addition, because there are merely minor changes of the prior art constant-voltage IC, the configuration of the circuit is relatively simple, and the manufacturing cost is relatively low.

In order to make the constant-voltage IC in the present invention have a dimming function, an enabling signal pin (ENA pin) of the constant-voltage IC is designated to receive a PWM dimming signal, wherein when the PWM signal is a high-level signal, the constant-voltage IC functions normally; and wherein when the PWM signal is a low-level signal, the constant-voltage IC is shut down.

As mentioned above, then referring to FIG. 3, the second embodiment of the present invention provides a method for driving backlight module, including the followings steps.

Step S1, providing a constant-voltage IC;

Step S2, connecting a voltage feedback pin leg of the constant-voltage IC to a negative electrode of an LED string; and

Step S3, providing a detecting resistor having one end connected to the negative electrode of the LED string, and the other end is grounded.

Substantially, before the voltage feedback pin leg of the constant-voltage IC is connected to the negative electrode of the LED string, a comparator with the voltage of its noninverting input end being identical to the voltage of its inverting input end is set within the constant-voltage IC, wherein the noninverting input end connects to the constant-voltage source, and wherein the inverting input end connects to the voltage feedback pin leg.

In order to make the constant-voltage IC in the present invention have a dimming function, the method further comprises the step of setting an enabling signal pin leg within the constant-voltage IC to receive a PWM dimming signal, wherein when the PWM signal is a high-level signal, the constant-voltage IC works normally; and wherein when the PWM signal is a low-level signal, the constant-voltage IC is shut down.

The third embodiment of the present invention provides an LCD apparatus incorporated with such a backlight driving circuit, including the driving circuit of backlight module made in accordance with the first embodiment of the present invention. To simplify the description, the structure of the driving circuit of backlight module and related working principle will not be repeated here as it can be readily referred to the above description.

The driving circuit of backlight module, the method for driving backlight module, and the LCD apparatus incorporated with such backlight module provided by the present invention use a various and low-costed constant-voltage IC. Changing the connection of its voltage feedback pin leg, so the constant-voltage IC can output the constant voltage and keep the current flowing through the LED string constantly, and thereby the constant-current driving is realized. Under the premise that the functions remain uncompromised, the complexity and the cost of the backlight driver circuit are reduced. In light of this, the voltage feedback pin leg could output the constant voltage by setting the comparator within the constant-voltage IC, so the voltage of its noninverting input end is identical to the voltage of its inverting input end, wherein the noninverting input end connects to the constant-voltage source. As a result, the configuration of the circuit is relatively simple, and easy to implement.

Preferred embodiments of the present invention have been described, but not intending to impose any unduly constraint to the appended claims. Any modification of equivalent structure or equivalent process made according to the disclosure and drawings of the present invention is considered encompassed in the scope of protection defined by the claims of the present invention.

1. A driving circuit of backlight module, comprising:
a constant-voltage IC, equipped with a voltage feedback pin leg, for outputting constant voltage, wherein the voltage feedback pin leg connects to a negative electrode of an LED string; and
a detecting resistor having one end connected to the negative electrode of the LED string, and the other end is grounded.

2. The driving circuit of backlight module as recited in claim 1, wherein the constant-voltage IC further includes a comparator, wherein the voltage of its noninverting input end is identical to the voltage of its inverting input end, wherein the noninverting input end connects to the constant-voltage source, and wherein the inverting input end connects to the voltage feedback pin leg.

3. The driving circuit of backlight module as recited in claim 2, wherein the constant-voltage IC further includes an enabling signal pin for receiving a PWM dimming signal, wherein when the PWM signal is a high-level signal, the constant-voltage IC works normally; and wherein when the PWM signal is a low-level signal, the constant-voltage IC is shut down.

4. A method for driving backlight module, including the steps of:
a) providing a constant-voltage IC;
b) connecting a voltage feedback pin leg of the constant-voltage IC to a negative electrode of an LED string; and
c) providing a detecting resistor having one end connected to the negative electrode of the LED string, and the other end is grounded.

5. The method for driving backlight module as recited in claim 4, wherein before the voltage feedback pin leg of the constant-voltage IC connects to the negative electrode of the LED string, a comparator with the voltage of its noninverting input end being identical to the voltage of its inverting input end is set within the constant-voltage IC, wherein the noninverting input end connects to the constant-voltage source, and wherein the inverting input end connects to the voltage feedback pin leg.

6. The method for driving backlight module as recited in claim 5, further comprising an enabling signal pin set in the constant-voltage IC for receiving a PWM dimming signal, wherein when the PWM signal is a high-level signal, the constant-voltage IC works normally; and wherein when the PWM signal is a low-level signal, the constant-voltage IC is shut down.

7. An LCD apparatus incorporated with such a backlight driving circuit, comprising:
a constant-voltage IC, equipped with a voltage feedback pin leg, for outputting constant voltage, wherein the voltage feedback pin leg connects to a negative electrode of an LED string; and
a detecting resistor having one end connected to the negative electrode of the LED string, and the other end is grounded.

8. The LCD apparatus incorporated with such a backlight driving circuit as recited in claim 7, wherein the constant-voltage IC further comprises a comparator, wherein the voltage of its noninverting input end is identical to the voltage of its inverting input end, wherein the noninverting input end connects to the constant-voltage source, and wherein the inverting input end connects to the voltage feedback pin leg.

9. The LCD apparatus incorporated with such a backlight driving circuit as recited in claim 8, wherein the constant-voltage IC further comprises an enabling signal pin for receiving a PWM dimming signal, wherein when the PWM signal is a high-level signal, the constant-voltage IC works normally; and wherein when the PWM signal is a low-level signal, the constant-voltage IC is shut down.
